(19) United States
(12) Patent Application Publication
(10) Pub. No.: US 2004/0065626 A1
(43) Pub. Date: Apr. 8, 2004

(54) Method and apparatus for separating blood components

(76) Inventor: Tony Woo, Boston, MA (US)

Correspondence Address: HANH T. PHAM, 4 WEST SIDE BLVD., BURLINGTON, CT, 06013, US

(21) Appl. No.: 10/262,805

(22) Filed: Oct. 2, 2002

(51) Int. Cl. B01D 43/00

(52) U.S. Cl. 210/767; 494/21

(57) ABSTRACT

A simple blood separation kit that is suitable for small surgeries for single-usage to separate whole blood into blood components, the separation kit comprising: a) two reservoirs for separating whole blood into blood components, each reservoir being connected to the other reservoir via a hollow tube at an outlet/inlet port, permitting transfer of blood components between said reservoirs; b) a pump mechanism in communication with the two reservoirs via the hollow tube and for injecting/suctioning blood components into and out of the reservoirs via the hollow tube; and c) a valve means for substantially closing the inlet/outlet port of the reservoirs while the pump mechanism is in operation injecting/suctioning blood components into or out of the reservoirs.

### FIELD OF THE INVENTION

The invention relates to a method and an apparatus for carrying out the method for separating blood components.

### BACKGROUND OF THE INVENTION

Blood or whole blood (“WB”) is composed of two parts: (1) plasma, the fluid portion, and (2) formed elements or suspended particles. The suspended particles constitute about 45 percent of the total volume of blood. They include erythrocytes (red blood cells), leukocytes (white blood cells), and platelets (thrombocytes). Autologous blood transfusion is a general term used to describe a procedure by which previously donated (or shed) blood is transfused (or re-infused) into the same donor or patient. Autologous blood separation is a general term used to describe a procedure in which blood is separated into separate components including plasma, red blood cells, platelet pellets “PP” or “platelet concentrate” (“PC”). PP/PC are being used in surgeries for the purpose of enhancing wound healing, which is an ability of the growth factors present in platelets. Plasma is being used, either after separation of the formed elements or after further concentration of the plasma factors (factor concentrates) by various means, for use in obtaining hemostasis, in improving handling characteristic of particulated bone graft materials, and/or as temporary wound barrier/dressing. Autologous blood separation is often carried out by elective or outpatient medical or dental offices, i.e., surgeries, for the above mentioned purposes, wherein only about 5 to 15 ml of PC is typically needed for a patient, which could be obtained from approximately 55 to 100 ml of whole blood.

It is known in the prior art to separate blood components through centrifugation. In the first spin of the centrifuge (the “soft spin”), whole blood is centrifuged to produce a precipitate of red blood cells (“RBC”) and a supernatant of platelet-rich plasma (“PRP”). The plasma is then transferred to another container for further separation in a second spin of the centrifuge (the “hard spin”) into platelet rich concentrates in the bottom and platelet-poor plasma at the top (“PPP”).

In one embodiment of the prior art, the separation system comprises an automated centrifuge and an integrally-attached multi-container system, whereby the separation of the blood components is effected by displacement of the centrifuged components from the first container into one or more second containers by an automatic decanting device. One of the major disadvantages of this system is the high cost due to its complexity.

PCT Patent Application WO 00/54825 (U.S. Pat. No. 6,325,750) provides a single-use kit tailored for small surgeries, particularly for autologous blood separation purposes. The system comprises multiple bags, with at least one of the bags serves as an inflatable device for the purpose of expressing supernatant liquid from the first compartment. The design of the system requiring multiple portals for pump or air sources to inflate the inflatable device is not optimum for a blood separation system, wherein it is desirable to minimize the possibility of blood contamination resulting from the multiple portals and the need for multiple steps in the use of the kit.

There is still a need for an improved system for separating blood components, without the requirement for a mechanical automatic decanting device or an inflatable device in the prior art.

### BRIEF SUMMARY OF THE INVENTION

The invention provides an apparatus for separating whole blood into blood components, the apparatus comprising: a) two reservoirs for separating whole blood into blood components, each reservoir being connected to the other reservoir via a hollow tube at an outlet/inlet port, permitting transfer of blood components between said reservoirs; b) a pump mechanism in communication with the two reservoirs via the hollow tube and for injecting/suctioning blood components into and out of the reservoirs via the hollow tube; and c) a valve means for substantially closing the inlet/outlet port of the reservoirs while the pump mechanism is in operation injecting/suctioning blood components into or out of the reservoirs.

In one embodiment, the invention provides a system for separating whole blood into blood components, with the two reservoirs being inflatable bags connected and supported by a centrifuge bucket having a cover support base, the pump mechanism being a syringe for injecting and suctioning blood components into and out of the two inflatable bags one at a time; and a three-way stopcock for selectively closing the inlet/outlet port of the bags while the syringe is in operation.

The invention further provides method for separating whole blood into blood components to collect platelet pellets, said method comprising: a) separating whole blood in a first reservoir into blood components; b) utilizing a pump mechanism in communication with the first reservoir and a destination reservoir via a hollow tube for transferring blood components from the first reservoir to the second reservoir via the hollow tube; c) further separating blood components in the second reservoir into platelet pellets; and d) utilizing the pump mechanism to collect the platelet pellets from the second reservoir.

### BRIEF DESCRIPTION OF THE DRAWINGS

The apparatus of the invention and the method for separating blood components in the present invention will be disclosed in greater detail with reference to the drawings, in which:

FIG. 1 is a front view of one embodiment of the apparatus of the present invention for separating blood components.

FIG. 2 is a perspective view of a second embodiment of the invention with two adjacent reservoir bags connected to a support base, a three-way stopcock and a syringe in connection with said stopcock for applying pressure to transfer blood components from the first bag to the second bag and vice versa.

FIG. 3A is a perspective view of a bifurcated centrifuge bucket for the two reservoir bags and the support base in FIG. 2.

FIG. 4 is a perspective view of a third embodiment of the invention, wherein the support base includes an integral divider extending downward thereby defining two compartments within a centrifuge bucket.

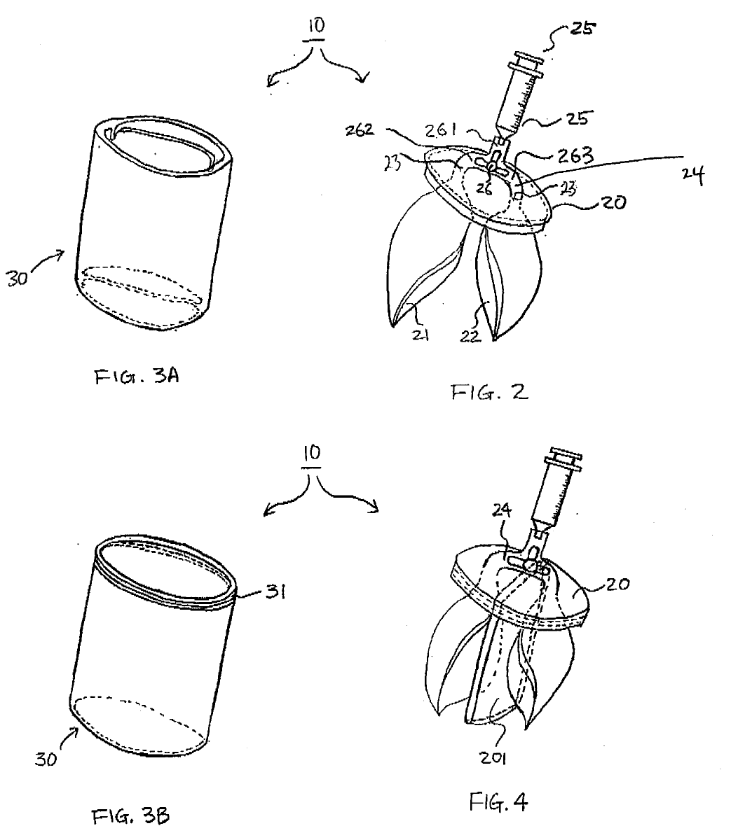

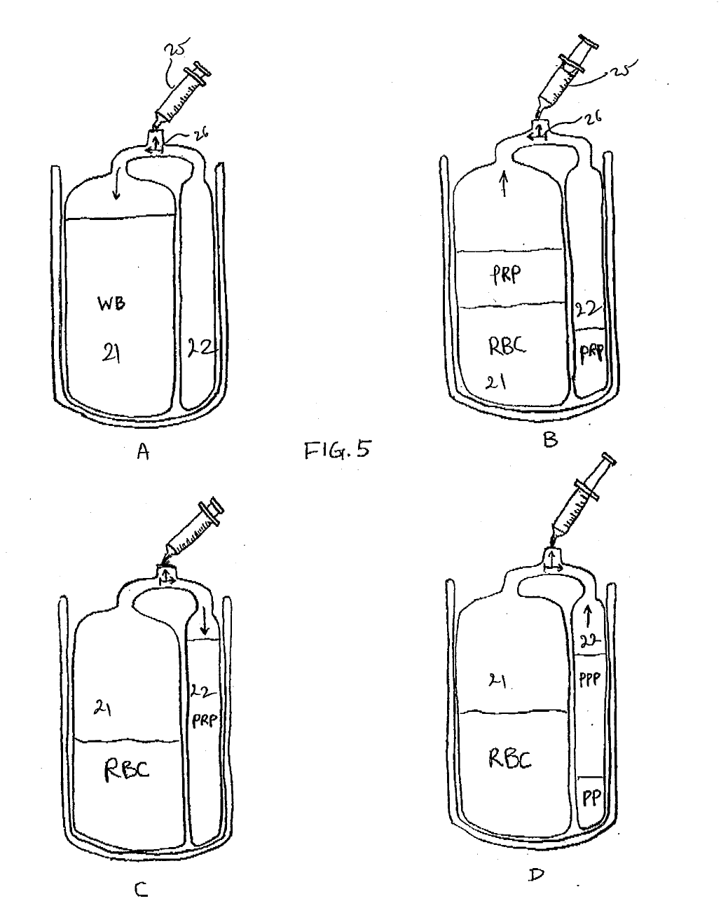

FIG. 3B is a perspective view of a centrifuge bucket for use in conjunction with the support base in FIG. 4.

FIGS. 5A, 5B, 5C, and 5D illustrate a method to separate blood components using the apparatus of the present invention.

FIG. 6 illustrates a latched centrifugal bucket for use with the assembly of the present invention.

FIG. 7 illustrates a centrifuge cup adapter holding an assembly of the present invention.

### DETAILED DESCRIPTION OF THE INVENTION

As used within, the terms “port” and portal are used interchangeably to indicate an entrance, entryway, an inlet, an outlet, or the point at which an entry and/or exit, or inlet and/or outlet is made.

As used within, the term “blood” includes whole blood as well as its components including, but not limited to, red blood cells, plasma, plasma factors, platelets, and leukocytes. Blood components, i.e., plasma, plasma factor concentrate, red blood cells, platelet pellets or “platelet concentrate” may be collectively referred to herein as “test specimen.”

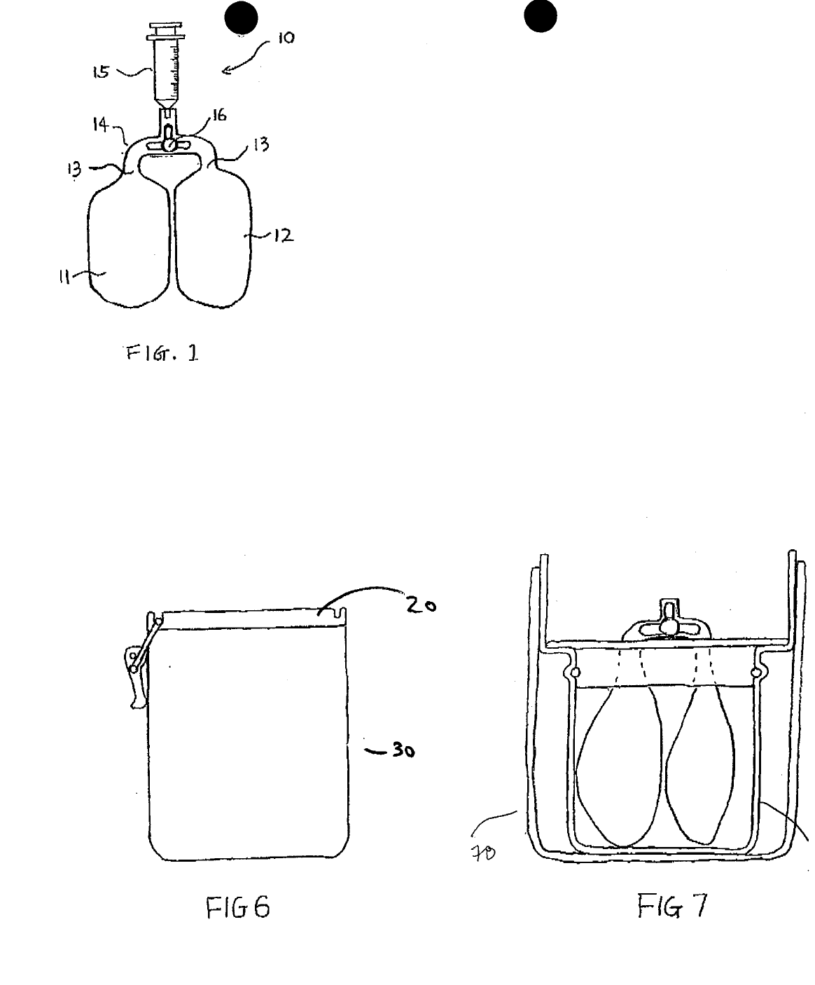

Referring to one embodiment of the invention as illustrated in FIG. 1, the apparatus 10 of the invention includes: two containers or reservoirs 11 and 12 with each reservoir having a portal 13; a hollow pipe or tube 14 for connecting the reservoirs at the portal 13; a pump or syringe mechanism 15 in fluid communication with the two reservoirs via said hollow tube 14 for transferring blood components into and between the two reservoirs; and a valve 16 in fluid communication with hollow tube 14 for substantially closing the portal of one of the reservoirs while the pump mechanism 15 is in operation injecting or suctioning blood components in or out of the other reservoir. The components of the apparatus can be made of any suitable materials including but not limited to metals and plastics.

In another embodiment of the invention as illustrated in FIG. 2, the reservoirs are two inflatable bags 21 and 22, each being connected to a hollow pipe or tube 24 via a support base 20 being circular in plain view with two portals 23 being openings on the support base 20. The transfer of blood between the two bags 21 and 22 is made possible by means of a syringe or suction pump 25 and a valve 26. As shown, a first port 261 of the valve 26 is for connecting the valve 26 to the pump 25, while the second and third ports 262 and 263 respectively connect valve 26 with hollow tube 24 and ultimately with the inflatable bags 21 and 22 via portals 13. In one embodiment of the invention as illustrated in FIG. 2, the valve 26 is a three-way valve (“3-way stopcock”) and the three-way valve is directly connected to portals 23 of the support base, eliminating the need for hollow tube 24.

As shown in FIG. 2, blood is sucked from the body cavity of the inflatable bags with the syringe 25, and by turning the three-way valve 26, blood is forced from the syringe 25 and thus transferred from one inflatable bag to another. The blood transfer/withdrawal mechanism of the present invention speeds up and simplifies the emptying of the body cavity from one bag to another.

In one embodiment, the inflatable bags, the support base, the housing, and the hollow tube are all made out of a medical or physiologically inert plastic material such as polyethylene, polypropylene, PVC, and the like. The syringe and 3-way stopcock are commercially available from standard medical supply sources such as Qosina of Edgewood, N.Y.

FIG. 3A shows a housing or centrifuge bucket 30 for receiving the assembly in FIG. 2 of inflatable bags 21 and 22 and the support base 20, with the support base 20 functioning as a cover plate for the housing bucket 30. The bucket 30 is bifurcated thereby defining two compartments within the bucket for receiving the two inflatable bags. In one embodiment of FIG. 2, support base 20 has an outwardly extending lip with inwardly extending protrusions, or snaps, spaced equidistantly along the circumference of the lip. The bucket 30 has an outwardly extending annular flange for receiving the snaps on the support base 20 and attaching the support base 20 to the bucket.

In one embodiment of FIG. 3 (not shown), the centrifuge bucket 30 further includes an elastomeric O-ring or gasket to further keep the bucket tightly seal and prevent any spillage of test specimen in the bags. As with the other components of the apparatus of the invention, the centrifuge bucket 30 can also be made out of a medical plastic material.

In another embodiment of the invention as shown FIG. 3B, the bucket 30 is not bifurcated. As shown in FIG. 4, the support base 20 for use in conjunction with the bucket 30 of FIG. 3B includes an integral divider 201. Integral divider 201 extends downward, thereby defining two compartments within the bucket for receiving the two inflatable bags 21 and 22 when the support base 20 is screwed onto the centrifuge bucket 30. In one embodiment of FIG. 3B, centrifuge bucket 30 comprises external threads 31 for receiving corresponding thread structure on support base 20 for a sealing arrangement when the bag assembly 10 is placed within the bucket.

The process of separating blood using the apparatus of the present invention is illustrated by reference to FIGS. 5A-5D. As known in the art, rotating a stopcock or valve will selectively establish communication between the ports on a 3-way stopcock. As shown in FIG. 5A, about 100 ml of whole blood is placed into inflatable bag 21 via syringe 25 and by selectively rotating the stopcock 26 and controlling the direction of the 3-way stopcock 26. By rotating the 3-way stopcock 26 in this first transfer phase, the flow between inflatable bag 21 and the syringe 25 (which is now connected to the 3-way stopcock) is open and the flows between inflatable bags 21 and 22 and between inflatable bag 22 and syringe 25 are automatically closed. After whole blood is placed into the bag, the syringe can be disconnected from the apparatus. The assembly of inflatable bags (with bag 21 containing whole blood) and support base with connecting tube is placed into the centrifuge bucket for a first spin in the bench-top centrifuge or commonly known in the art as the “soft spin.”

After about 2-4 minutes of centrifuging, whole blood is separated into two phases, a bottom layer of red blood cells (“RBC”) and a top layer of supernatant of platelet-rich plasma (“PRP”). The centrifuge bucket 30 is removed from the rotor of the centrifuge so that bag 21 can be accessed for the transfer phase.

As shown in FIG. 5B, the top layer PRP is aspirated into syringe 25 by way of the open flow between connecting tube 24 into syringe 25 when the plunger is pulled back in the syringe. After the syringe has reached its maximum capacity or when a desirable amount of PRP is aspirated into the syringe barrel, the 3-way stopcock is then selectively rotated to switch the direction of flow to be solely between syringe 25 and the second inflatable bag 22. In this next transfer step when the syringe plunger is depressed, the PRP is injected from the syringe barrel into bag 22. If it is necessary and/or desirable to fully transfer all of the PRP from bag 21 to bag 22, the aspiration and injection steps are repeated via selective rotations of the 3-way stop cock in conjunction with the operation of the syringe 25 to aspirate the top layer PRP from bag 21 into syringe 25, and then to eject the PRP from the syringe 25 into bag 22.

FIG. 5C illustrates the assembly prior to the second spin or centrifuge stage. After a desirable amount of PRP has been isolated and collected in bag 22, the assembly of inflatable bags (with bag 22 containing the PRP) and support base with connecting tube is placed into the centrifuge bucket for the second spin in the bench-top centrifuge or also known as the “hard spin.” In this second spin and as illustrated in FIG. 5D, the PRP in bag 22 is separated into a top layer of plasma without platelets (“PPP”) and a heavy bottom layer with desirable platelet pellet (“PP”). After about 10 to 13 minutes of centrifuging to obtain the desired separation of PPP and PP, the assembly is removed from the rotor of the centrifuge so that bag 22 can be accessed. In order to access the PP at the bottom layer of bag 22, the 3-way stopcock is first selectively rotated so that there is an open flow between inflatable bag 22 and the syringe 25 (connected to the 3-way stopcock). The top layer PPP is next aspirated into the syringe barrel when the plunger is pulled back in the syringe barrel. The PPP collected in the syringe barrel can be ejected from the syringe 25 into bag 21 (now containing discarded RBC) or another container for further processing, i.e., saved for concentration and collection of plasma factors, or to be discarded as medical waste. This back-and-forth aspiration of the PPP from bag 22 via the operation of the syringe 25 continues until the top layer PPP is removed, leaving the platelet pellet PP in the bag for surgical uses.

In the embodiment as shown, the valve means is a single 3-way stopcock having multiple ports for open fluid communication between the connecting tube, the two inflatable bags as reservoirs, and the syringe as a pump/collection means. The assembly of 3-way stopcock, inflatable bags, optional support base, and connecting tube can be one “whole assembly” or integral as known in the medical disposable plastic art, with plastics connections being fused together thermally or by other means. In another embodiment, plastic clamps commonly used in medical/laboratory art can be used to securely connect the ports on inflatable bags with the connecting tube and the 3-way stopcock.

Also in the embodiment as shown, the two inflatable bags are in connection with a support base and the connecting tube and further contained by a centrifuge bucket for structurally support in a centrifuge spin. In another embodiment, other types of valves can be used, e.g., a 4-way stopcock with the 4^{th} port for open communication between the syringe and a disposal bag for collecting the plasma without platelet (“PPP”).

In yet another embodiment, multiple valves can be used instead of a single 3-way stopcock as shown, i.e., 2-way valves for connecting the reservoirs with the connecting tube and additional valves for connecting the connecting tube with the syringe, with the use of plastic clamps as a separating mean.

In a fourth embodiment wherein multiple valves are used, each reservoir with connecting valve has its own centrifuge bucket and cover base to be suitably placed into the rotating rotor in spin cycles.

Centrifuging assemblies for use in conjunction with the apparatus 10 of the present invention are well-known in the art for separating substances of varying density by centrifugal force. These centrifuge means, for the most part, comprise an outer housing with an inner-rotating rotor which is spun by a motor driven spindle at variable speeds. Carriers containing the samples or test specimen are located on the circumference of the rotor. In yet another embodiment, the centrifuge means is a typical lab bench-top centrifuge with varying speed of up to 6000 rpm with the rotor capacity being sufficient to hold in place the centrifuge bucket housing the apparatus of the present invention.

When used in conjunction with the apparatus of the present invention and as shown in FIG. 6, the centrifuge bucket 30 for use with centrifuging assemblies is provided with a latchable lid that remains latched during an operation cycle of the unit thus keeping the carriers assembly in place while the test specimen are being separated and until the rotor stops rotating. In another embodiment as shown in FIG. 7, which illustrates a centrifuge cup adapter holding an assembly of the present invention, placed inside a centrifuge cup, which may be longer and/or wider than the assembly of the present invention. Such an adapter would allow the use of the assembly, which may be manufactured for a pre-determined range of blood volumes, to be used in centrifuge cups that are larger. The centrifuge bucket 30 further comprises an insert 70 or outer housing 70 to accommodate the apparatus of the present invention with commercially available or large centrifuging assemblies.

Although the present invention is particularly useful as a single-use and/or disposable blood separation kit tailored for small surgeries, the apparatus provided herein may also be “reused” multiple times. It may also be used for separating, mixing and/or selectively removing and/or collecting of other biological or chemical samples other than blood.

What is claimed is:

1. An apparatus for separating whole blood into blood components plasma, red cells, and platelet concentrate, said apparatus comprising:
a first and second reservoirs, each reservoir having a port means and each reservoir being connected to the other reservoir via a valve means, permitting transfer of blood components between said reservoirs;
a pump mechanism for permitting transfer of blood components between said first and second reservoirs via said valve means, said pump mechanism having a barrel for containing blood components and a plunger sidably positioned within said barrel for suctioning blood components from one of said two reservoirs into the barrel during a suction stroke of the plunger and for injecting blood components from the barrel into one of said reservoirs during an injecting stroke of the plunger;
wherein said valve means is in fluid communication with said pump mechanism and said two reservoirs for substantially closing the port means of one of said reservoirs while said pump mechanism is in operation suctioning blood components from or injecting blood components into the other reservoir.

2. The apparatus of claim 1, further comprising a hollow tube for connecting said first and second reservoirs with said valve means.

3. The apparatus of claim 1, wherein said valve means is a three-way valve.

4. The apparatus of claim 1, wherein said reservoirs are expandable bags.

5. The apparatus of claim 1, wherein said pump mechanism is a syringe.

6. The apparatus of claim 1, further comprising a support base to which the pump mechanism is mountable.

7. The apparatus of claim 1, further comprising a support base for securing said first and second reservoirs.

8. The apparatus of claim 7, wherein said a support base for securing said first and second expandable bags comprises an integral wall for separating and supporting said first and second expandable bags.

9. The apparatus of claim 1, further comprising a housing for receiving said first and second reservoirs.

10. The apparatus of claim 9, wherein said housing is securely fastened to said support base via at least one of the following mechanisms: a gasket, a clamp, thread, and a latch.

11. The apparatus of claim 9, wherein said housing for receiving said first and second reservoirs comprises an integral wall for separating said first and second reservoirs.

12. The apparatus of claim 1, further comprising a motor means for rotating said first and second reservoirs at a separation speed, wherein rotation of the reservoirs causes the blood components to separate from one another within reservoirs.

13. A method for separating whole blood into blood components to collect platelet pellets, said method comprising:
a) separating whole blood in a first reservoir into blood components;
b) utilizing a pump mechanism in communication with a valve means, the first reservoir, and a second reservoir for transferring blood components from the first reservoir to the second reservoir, said pump mechanism having a barrel for containing blood components and a plunger slidably positioned within said barrel for suctioning blood components from one of said two reservoirs into the barrel during a suction stroke of the plunger and for injecting blood components from the barrel into one of said reservoirs during an injecting stroke of the plunger, and said valve means comprising a switch mechanism for substantially closing one of the said reservoirs while said pump mechanism is in operation;
c) further separating blood components in the second reservoir into platelet pellets; and
d) utilizing the pump mechanism to collect the platelet pellets from the second reservoir.

14. The method of claim 13, wherein said valve means is a three-way valve.

15. The method of claim 13, wherein said reservoirs are expandable bags.

16. The method of claim 13, wherein said pump mechanism is a syringe.

17. A centrifuge system for separating whole blood into blood components plasma, red cells, and platelet concentrate, said system comprising:
a) a rotor;
b) an support bucket being disposed in said rotor for rotation herewith;
c) a first and second reservoirs being secured to a support base, each reservoir having a port means and each reservoir being connected to the other reservoir via a valve means, permitting transfer of blood components between said reservoirs;
d) a pump mechanism for permitting transfer of blood components between said first and second reservoirs via said valve means, said pump mechanism having a barrel for containing blood components and a plunger slidably positioned within said barrel for suctioning blood components from one of said two reservoirs into the barrel during a suction stroke of the plunger and for injecting blood components from the barrel into one of said reservoirs during an injecting stroke of the plunger;
wherein:
said valve means is in fluid communication with said pump mechanism and said two reservoirs for substantially closing the port means of one of said reservoirs while said pump mechanism is in operation suctioning blood components from or injecting blood components into the other reservoir; and
said support base is adapted to fit within said bucket.
